(19) United States
(12) Patent Application Publication
(10) Pub. No.: US 2013/0123034 A1
(43) Pub. Date: May 16, 2013

(54) APPARATUS, METHOD, SYSTEM AND COMPUTER PROGRAM PRODUCT FOR RECORDING AND REVIEWING DIGITAL VIDEO MEDIA OF A GOLF SWING

(71) Applicant: Ryan Pohl, Hamden, CT (US)

(72) Inventor: Ryan Pohl, Hamden, CT (US)

(21) Appl. No.: 13/297,032

(22) Filed: Nov. 15, 2011

(51) Int. Cl. A63B 69/36; G06F 19/00

(52) U.S. Cl. 473/220; 473/221; 700/91

(57) ABSTRACT

A golf swing training apparatus, system, method and computer program product is disclosed for recording and providing digital review a media recording of a filmed golf swing. The golf swing training apparatus allows a golfer to pay to have his/her swing digitally recorded simultaneously from a plurality of camera perspectives, and to review video media of the golf swing in slow motion so as to improve technique, posture, and swing trajectory. The golf swing training apparatus, in one embodiment, comprises a plurality of cameras, an interface for prompting a golfer to make payment, and a display for reviewing footage of a golf swing from one of a plurality of perspectives. In some embodiments, flashing lights inform the golfer that the recording is about to begin.

### BACKGROUND OF THE INVENTION

1. Field of the Invention

This invention relates to golfing devices, and more particularly relates to systems, methods and apparatii for improving golf swings.

2. Description of the Related Art

Many golfers have a desire to improve their golf swings, consequently improving their golf game. High precision is required during putting and driving to improve a golfer's score. Many factors influence the speed and trajectory of a golf ball while in flight or while rolling on a green, including the angle of the club face at impact and the speed of the club at impact, as well as the posture of the golfer while swinging. While many devices have been proposed to improve a golfer's posture and the direction of the golf club when striking a golf ball, all the devices in the art suffer from various weaknesses.

Apparatii, systems and methods which are meant to improve a golfer's posture, technique, swing trajectory and drive distance are known in the art. Some of these apparatti include cumbersome swing training devices, which cannot be easily transported from one location to another, and which assist golfers only in improving only type of golf swing without affording the golfer the opportunity for visual review of a deficient swing from a third-party perspective.

Although these devices can assist a golfer in certain aspects of the golf swing, the present inventor is unaware of any device that can assist the golfer in filming an actual golf swing from a plurality of perspectives, or of providing slow motion review of the swing. Such a machine would be beneficial as it would allow a golfer to review all aspects of a golf swing on camera, rather than attempting to visualize errors being explained to the golfer by a coach or trainer.

These devices known in the art do not allow a golfer to selectively improve a type of swing to work on, such as putting, chipping pitching or driving. Accordingly, there is a need for a golf swing training device that can be used to assist the golfer in improving, inter alia, posture, drive distance and technique.

### SUMMARY OF THE INVENTION

From the foregoing discussion, it should be apparent that a need exists for an apparatus, method, system and computer program product for recording and facilitating review of digital video media of a golf swing. Beneficially, such a measuring device would overcome many of the difficulties with prior art by providing a more functional apparatus to golfers and golf coaches which can be used where other devices are deficient.

The present invention has been developed in response to the present state of the art, and in particular, in response to the problems and needs in the art that have not yet been fully solved by currently available apparatii, computer program products, and methods. Accordingly, the present invention has been developed to provide a system for improving a golf swing, the system comprising: a planar standing pad resting on a ground surface for supporting a golfer swinging a golf club; two or more digital cameras, each camera pointed at a center of the standing pad, each camera affixed to one a plurality of camera stands; two or more camera stands, each camera stand detachably affixed to a camera, the camera stands affixed to the standing pad; three of more cables, each cable interconnecting one of the cameras with a DPD (data processing device); a DPD in logical communication with the first display and the second display, the DPD networked to an Internet; an interface for receiving payment information entered by a golfer, the first display in logical connection with the DPD; a display for displaying video media shot by the cameras; and a persistent computer readable storage for storing video media shot by the cameras.

In some embodiments, the system further comprises a prompter module configured to prompt a golfer to input a number of swings the golfer wishes to pay to have reviewed; an incorporation module configured to incorporate a golfer into a virtual framework, the incorporation module configured to store the golfer's name and email in a database record in the persistent computer readable storage; a payment module configured to accept a credit card payment from the golfer, the payment a function of the number of swings selected by the golfer; a hand selector module configured to prompt the golfer to identify himself/herself as one of a right-handed golfer and a left-handed golfer; and a recorder module configured to record the swing of the golfer from a plurality of perspective, the recordings of the golf swing from each perspective stored in persistent computer readable memory; and a transfer module configured to transfer a video recording of the golfer's swing as an attachment to the email address.

The system may further comprise: a lighter module configured to flash one or more light(s) to indicate to the golfer that video recording is about to ensue; and one or more light(s) connected the lighter module.

In some embodiments, a command module is configured to recognize a plurality of commands uttered orally by the golfer, such as commands to commence recording, charge a credit card for an additional swing, or to erase a previous recording.

A golf swing review device is also disclosed comprising: a planar standing pad resting on a ground surface for supporting a golfer swinging a golf club; two or more digital cameras affixed to the standing pad, each camera pointed at a center of the standing pad, the cameras each affixed to a camera stand; two or more camera stands, each camera stand detachably affixed to a camera, the camera stands resting on the ground surface; two of more cables, each cable interconnecting one of the cameras with a DPD (data processing device); an interface for receiving payment information entered by a golfer, the first display in logical connection with the DPD; a display for displaying video media shot by the cameras; and a DPD in logical communication with the first display and the second display, the DPD networked to an Internet.

The display may face the standing pad such the golfer can see the display while standing on the pad. The golf swing review device may further comprise one or more light(s) configured to flash so as to indicate that recording of a golf swing is about to begin.

The golf swing review device may further comprise two or more disassemblable, interconnectable walls surrounding the standing pad.

The computer program product may perform operations for recognizing a golfer's 102 voice, fingerprints, or eyes using means and physical components known to those of skill in the art. In those embodiments, the DPD authenticates, or recognizes the golfer's 212 voice, fingerprints or eyes and accesses videos and/or payment information exclusively associated with that golfer 212.

A computer program product comprising a computer readable medium having computer usable program code executable to perform operations for providing visual review of recorded golf swing is also disclosed, the operations of the computer program product comprising: prompting a golfer to input a number of swings the golfer wishes to pay to have reviewed; incorporating a golfer into a virtual framework, the incorporation module configured to store the golfer's name and email in a database record in the persistent computer readable storage; accepting a credit card payment from the golfer, the payment a function of the number of swings selected by the golfer; prompting the golfer to identify himself/herself as one of a right-handed golfer and a left-handed golfer; and recording the swing of the golfer from a plurality of perspectives, the recordings of the golf swing stored in persistent computer readable memory; and transferring a video recording of the golfer's swing as an attachment to the email address.

The computer program may further comprise: counting down the seconds until recording starts, and displaying a countdown on a display. The computer program product may further comprise: prompting the golfer to replay footage of the golfer's recorded swing on a display, the golfer prompted to display footage from one of a first perspective, a second perspective, a third perspective, or all perspectives; and playing the recorded media on the display in slow motion from the selected perspective(s) in response to the golfer starting replay.

The computer program product may further comprise: prompting the golfer to start a slow motion replay of the golfer's recorded swing on a display; and playing the recorded media on the display in slow motion in response to the golfer starting replay.

The computer program product may further comprising: prompting the golfer to select from one of one or more perspective views used to record the golfer's swing; and playing the recorded media footage taken from the selected perspective on the display in slow motion in response to the golfer starting replay.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a rear elevational perspective view of a device for recording and facilitating review of digital video media of a golf swing in accordance with the present invention;

FIG. 2 is a side perspective view of a system for recording and facilitating review of digital video media of a golf swing in accordance with the present invention;

FIG. 3 is a side elevational perspective view of a system for recording and facilitating review of digital video media of a golf swing in accordance with the present invention;

FIG. 4 is an interior environmental perspective view of a system for recording and facilitating review of digital video media of a golf swing in accordance with the present invention;

FIG. 5 is an entity-data relationship diagram of some of the modules of system for recording and facilitating review of digital video media of a golf swing in accordance with the present invention;

FIG. 6 is a block diagram of the modules of system for recording and facilitating review of digital video media of a golf swing in accordance with the present invention; and

FIG. 7 is a flow chart of the steps of a method or computer program product or recording and facilitating review of digital video media of a golf swing in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

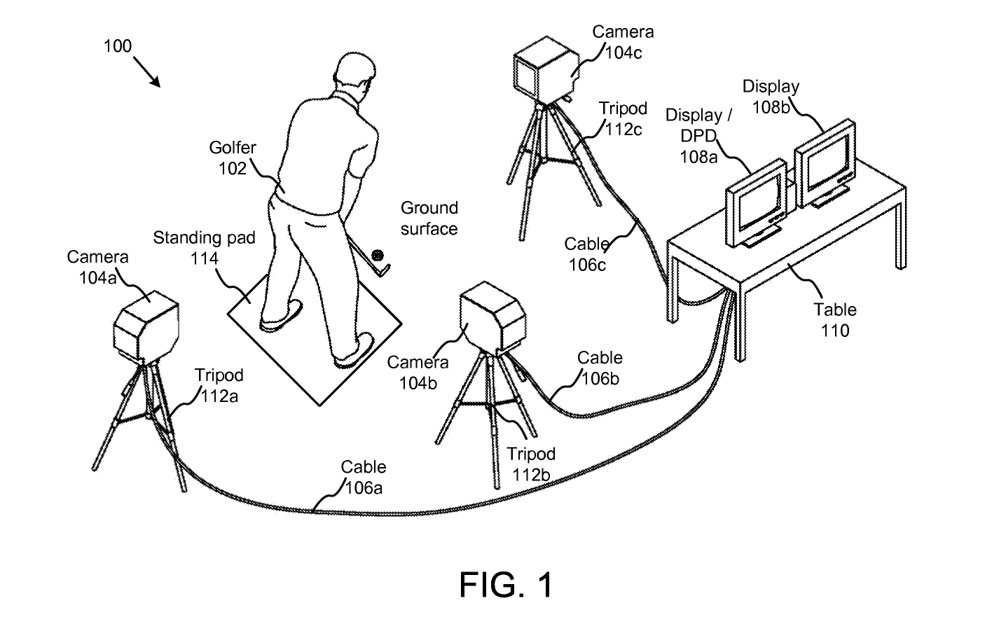

FIG. 1 is a rear elevational perspective view of a device 100 for recording and facilitating review of digital video media of a golf swing in accordance with the present invention. The device 100 comprises, in the shown embodiment, a camera 104a, a camera 104b, a camera 104c, a cable 106a, a cable 106b, a cable 106c, a display 108a, display 108b, a table 110, a tripod 112a, a tripod 112b, a tripod 112c, and a standing pad 114. A golfer 202 is also shown.

The cameras 104a-c, in the shown embodiment, each comprise high speed digital cameras capable of recording 100 frames per second or higher. These cameras 104a-c are outfitted with wide angle lenses.

The cameras 104a-c sit upon tripods 112a-c. The tripods 112a-c rest upon the edges of the standing pad 114. In some embodiments, the tripods 112a-c are detachably affixed to the standing pad 114. In other embodiments, the tripods 112a-c rest on a ground surface and encircle the standing pad 114. The cameras 104a-c may also be mounted on camera stands alternatively.

The cameras 104a-c are affixed to cables 106a-c, which cables 106a-c interconnect the cameras 104a-c with a data processing device (DPD), such as a server, computer workstation, router, mainframe computer, or the like. In various embodiments, the DPD comprises one or more processors. The processor is a computing device well-known to those in the art and may include an application-specific integrated circuit (“ASIC”).

Typically, the DPD comprises one or more central processing units executing software and/or firmware to control and manage the other components or modules. In the shown embodiments, the display 108a comprises a DPD which interfaces with the other functional components of the device 100. The DPD 108a may comprise all, or party, of the hardware and/or software necessary to run the device 100, including a display 100, as well as Multiple Virtual Storage (MVS), OS/390, zSeries/Operating System (z/OS), UNIX, Linux, or a solid state hard drive.

The display 108b exists for allowing review of a golf swing recorded by the cameras 104a-c. In some embodiments, the display 108b also comprises a DPD and/or persistent computer readable storage. The persistent storage provides persistent storage of data, including video media files recorded by the cameras 104a-c. The persistent storage stores computer readable database files.

The table 110 is well-known to those of skill in the art.

The standing pad 114 comprises a planar pad upon which the golf 102 positions himself during recording of a golf swing. The standing pad 114 rests upon a ground surface or subgrade, and may be formed from nylon, woven organic fabrics, rigid or flexible elastomeric materials, wood, metal, alloys, or with other materials known to those of skill in the art. In some embodiments, the standing pad 114 simply comprises a surface area designated on the ground by paint, chalk, or other markings.

The tripods 112a-c comprise three-legged camera stands, and are well-known to those of skill in the art. Alternatively, the cameras 104a-c may be mounted on camera stands of any type. The cameras 104a-c may also be mounted on walls or poles.

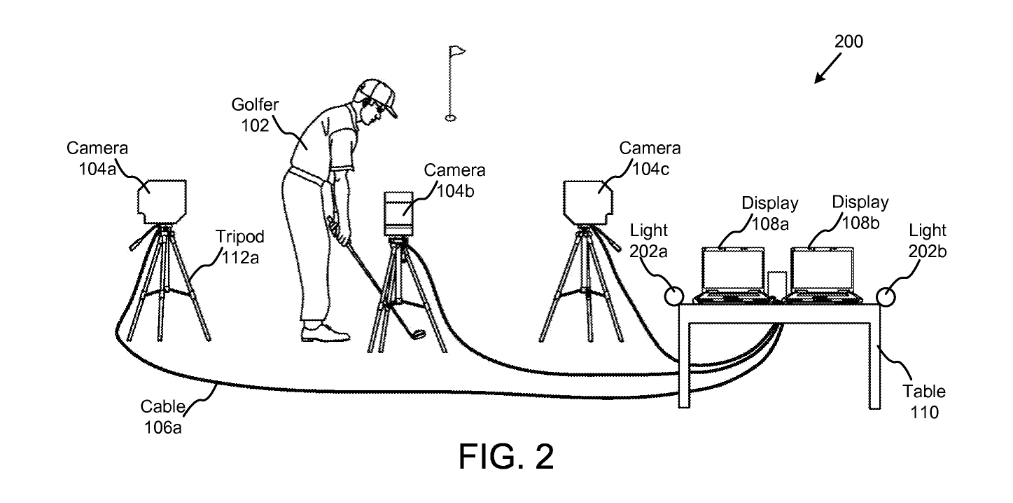

FIG. 2 is a side perspective view of a system 200 for recording and facilitating review of digital video media of a golf swing in accordance with the present invention. The system 200 comprises, in the shown embodiment, a camera 104a, a camera 104b, a camera 104c, a cable 106a, a display 108a, display 108b, a table 110, a tripod 112a, a light 202a, and a light 202b. A golfer 202 is also shown.

Those of skill in the art recognize that the system 200 may be more simple or complex than illustrated so long as the system 200 includes modules or sub-systems that correspond to those described herein. The server 102 may comprise a computer program running on one or more data processing devices (DPDs), such as a server, computer workstation, router, mainframe computer, or the like.

In the shown embodiment, the DPD 108a creates golfer records from information gathered electronically from golfers 102 being filmed by the cameras 104a-c. In the shown embodiment, the cameras 104a-c communicate with the DPD 108a via the cables 10a-c, but this communication may be effectuated wirelessly through an SMS Gateway Provider using a Short Message Service (SMS) or Multimedia Message Service (MMS) message.

The DPD 108a may also be in logical communication with a golfer 102 through a networked environment, such as local area network (LAN) or wide area network (WAN), including the wireless network. The DPD 108a may send recorded video media to the golfer 102 wirelessly to personal DPDs such as laptops, Palm Pilots®, digital cameras, personal gaming system, and the like.

In some embodiments, the DPD 108a is in logical communication, or networked communication, via the Internet with one or more third-party websites. The DPD 108a is configured to transfer a copy of the recorded video media to the golfer via means selected by the golfer before payment is remitted. The DPD 108a-b may communicate with the golfer 102 using Simple Mail Transfer Protocol (SMTP), Internet Message Access Protocol (IMAP), Post Office Protocol (POP), or other protocols well-known to those of skill in the art.

The information gathered by the system 200 is stored in computer readable memory.

The display 108a is equipped, in the shown embodiment, with a touch interface for accepting commands and payment from the golfer 102. In other embodiments, the interface may comprise, internally or externally, an Interactive Voice Response (IVR), which recognizes verbal and keypad input from golfers 102 to the system 200.

The system 200 comprises lights 202a-b. Some embodiments of the present invention include only one light 202. Other embodiments include a plurality of lights 202. These lights 202a-b are affixed to the table 110 or another component of the system 100 where the golfer 102 can see them as he is preparing to swing a golf club while being recorded by the cameras 104a-c. In various embodiments of the present invention, these lights 202a-b are configured to flash in various patterns indicative of the commencement of the recording. In other embodiments, the color of the lights 202a-b indicates a phase of the recording, such as a pre-recording phase, the recording phase, or the post recording phase.

The lights, like all of the components of the system 200, may be powered by 120 volt alternating current, 12 volt direct current, or other means known to those of skill in the art.

The cameras 104a-c, cable 106a, display 108a, display 108b, table 110, and tripod 112a are all substantially described above in relation to FIG. 1.

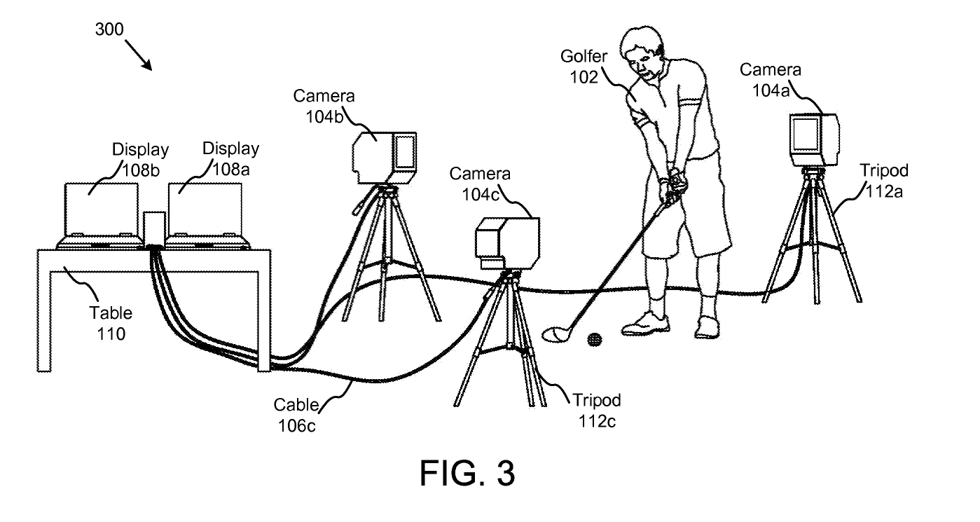

FIG. 3 is a side elevational perspective view of a system 300 for recording and facilitating review of digital video media of a golf swing in accordance with the present invention. The system 300 comprises, in the shown embodiment, a camera 104a, a camera 104b, a camera 104c, a cable 106c, a display 108a, display 108b, a table 110, a tripod 112c, a light 202a, and a light 202b. A golfer 202 is also shown.

The cameras 104a-c, cable 106c, displays 108a-c, table 110, and tripod 112c are all substantially described above in relation to FIG. 1.

The cameras 104a-c may be oriented in any position around the golfer 102. The cameras 104a-c themselves may serve as markers of the standing pad 114.

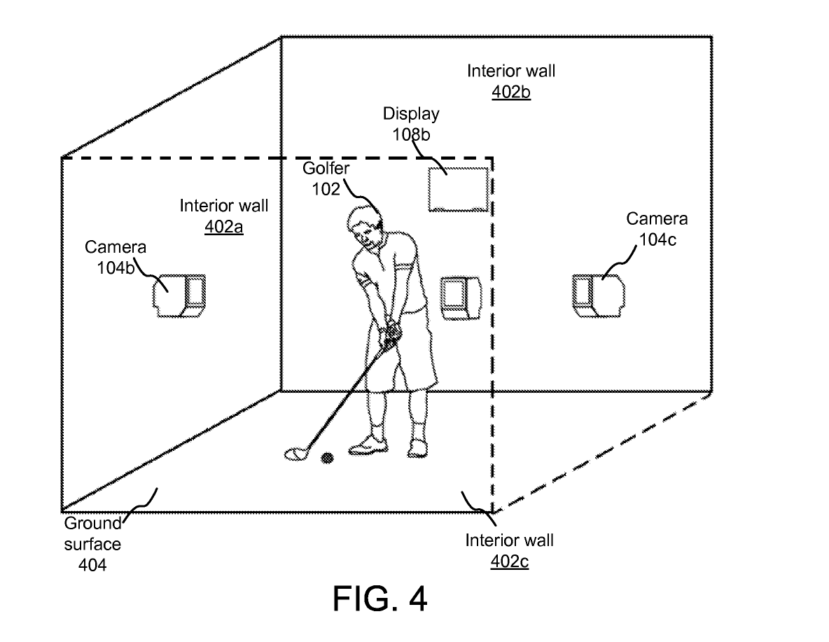

FIG. 4 is an interior environmental perspective view of an apparatus 400 for recording and facilitating review of digital video media of a golf swing in accordance with the present invention. The apparatus 400 comprises an interior wall 402a, an interior wall 402b, an interior wall 402c, a display 108c, a ground surface 404, and cameras 104a-c. A golfer 102 is also shown.

In some embodiments of the present invention, the cameras 104a-c are mounted on walls 402a-c as shown. In those embodiments, the cameras 104a-c are interconnected with the other components forming the apparatus with cables 106a-c. In some embodiments, the walls 402a-c themselves form part of the apparatus 400.

In some embodiments of the present invention, the room formed by the walls 402a-c and the ground surface 404 is assemblable and portable. Wall 402c, in some embodiments, is absent from the apparatus 400. In those embodiments, the wall 402c is missing such that the golfer 102 may drive a golfball through the recess defined by the room where wall 402c would have sat.

The cameras 104a-c may be mounted to the walls 402a-c using brackets or other means known to those of skill in the art.

The display 108b may also be mounted to one of the walls 402a-c. The display 108c may comprise a touchscreen and DPD together.

Some embodiments of the present invention comprise a kiosk in a mall. The kiosk comprises the walls 402a-c and other components substantially described above. In those embodiments, the present invention may also be used to video record not only the golf swing of a golfer 102, but an entire golfer lesson given to the golfer 102 by a golf professional such that the golfer 102 may review advise and technical assistance offered previously to the golfer 102. In those embodiments, one or more of the golfer 102 and/or the golf professional may instruct the apparatus 400 to begin recording and stop recording manually using means known to those of skill in the art, including depressing a button, voice recognition, and the like.

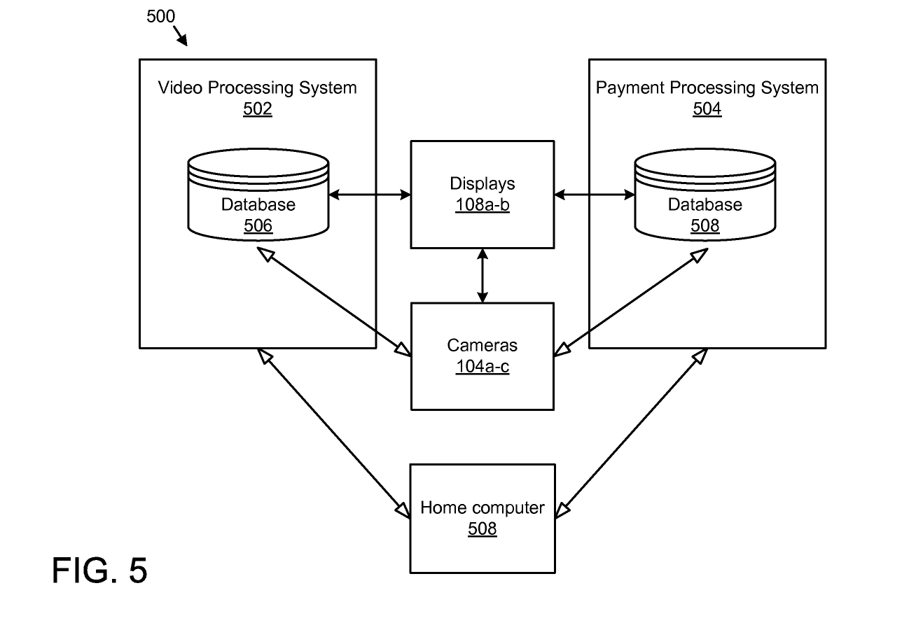

FIG. 5 is a data-entity relationship diagram of some of the modules of system 500 for recording and facilitating review of digital video media of a golf swing in accordance with the present invention.

In the shown embodiment, the cameras 104a-c are in logical communication with a video processing system 502 and with a payment processing system 504. Both of the systems 504, 506 comprise databases (database 506 and database 508 respectively), which databases 506, 508 store video media files in persistent computer readable memory.

The systems 402, 404 are in communication with the displays 108a-b, and the systems 502, 504, interfacing with the displays 108a-b, can replay recorded video media on one or more of the displays 108a-b.

The systems 502, 504 are also in communication with a home computer 508 via the Internet. These systems 502, 504 may instructed by the golfer 102 via the displays 108a-b to email or upload recorded video media to the home computer 508.

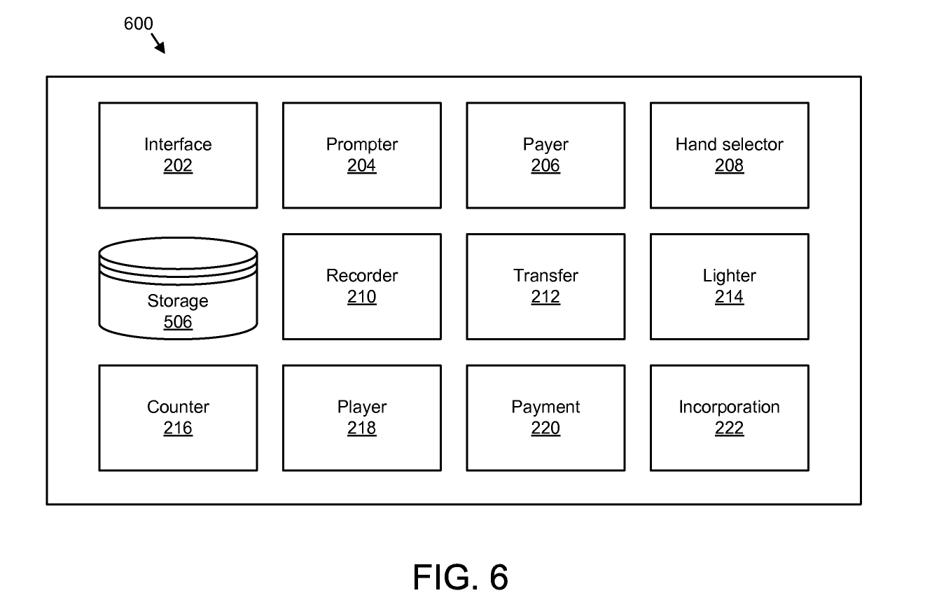

FIG. 6 is a block diagram of the modules of system 600 for recording and facilitating review of digital video media of a golf swing in accordance with the present invention. The system 600 comprises an interface module 202, a prompter module 204, a payer module 206, a hand selector module 208, persistent storage 506, a recorder module 210, a transfer module 212, a lighter module 214, a counter module 216, a player module 218, a payment module 220, and an incorporation module 222.

The interface module 202 is described above in relation to FIGS. 1-5, and may consist of the DPD 108a.

The prompter module 204 is configured to prompt a golfer 102 to input a number of swings the golfer wishes to pay to have reviewed. The golfer 102 may input this information via the DPD 108a.

The incorporation module 222 may be configured to incorporate a golfer 102 into a virtual framework by storing the golfer's 102 name and email in a database record in the persistent computer readable storage 506.

The payment module 220 may be configured to accept a credit card payment from the golfer 102. The payment may be made via the DPD 108a. The payment, in the present invention, is a function of the number of swings selected by the golfer 102 for recoding and review.

The hand selector module 208 is configured to prompt the golfer 102 to identify himself/herself as either a right-handed golfer and a left-handed golfer. In some embodiments, only one of a plurality of the cameras 104a-c is activated. In those embodiments, only the camera 104 that is best positioned to film the golfer 102 from either a right-handed or left-handed position is activated. In some embodiments of the present invention, the cameras 104a-c are on a circular track circumscribing the standing pad 114. The cameras 104a-c may be configured to axially rotate the standing pad 114 so as to film the golfer from any position on the track.

The recorder module 210 may be configured to record the swing of the golfer 102 from any one of a plurality of perspectives, or from all perspectives simultaneously. The recordings of the golf swing from each perspective are stored in persistent computer readable memory. The recorder module 210 instructs the cameras 104a-c to being filming, and when to quit filming.

The transfer module 212 is configured to transfer a video recording of the golfer's 102 swing to the home computer 408 as an attachment to an email. In various embodiments, the golfer 102 receives an email originating with the transfer module 212. This email, in some embodiments, contains a hyperlink to a website comprising video of the golfer's 212 recorded swing(s). This hyperlink may comprise a number, string, or other unique identifier exclusively associated with the golfer 212 such that the website can automatically direct the golfer 212 arriving at the website to an appropriate subpage on the website comprises links to videos of the golfer's 212 swing(s).

The lighter module 214 is configured to flash the lights 202a-b preparatory to the commencement of the recording.

The payer module 206 is configured to process a payment from the golfer 102 via the Internet.

The counter module 216 is configured to display a second countdown on the display 108b, indicating the amount of time until the recording begins.

The player module 218 is configured to play back recording video media to a golfer after recording on one of the display 108a and the display 108b.

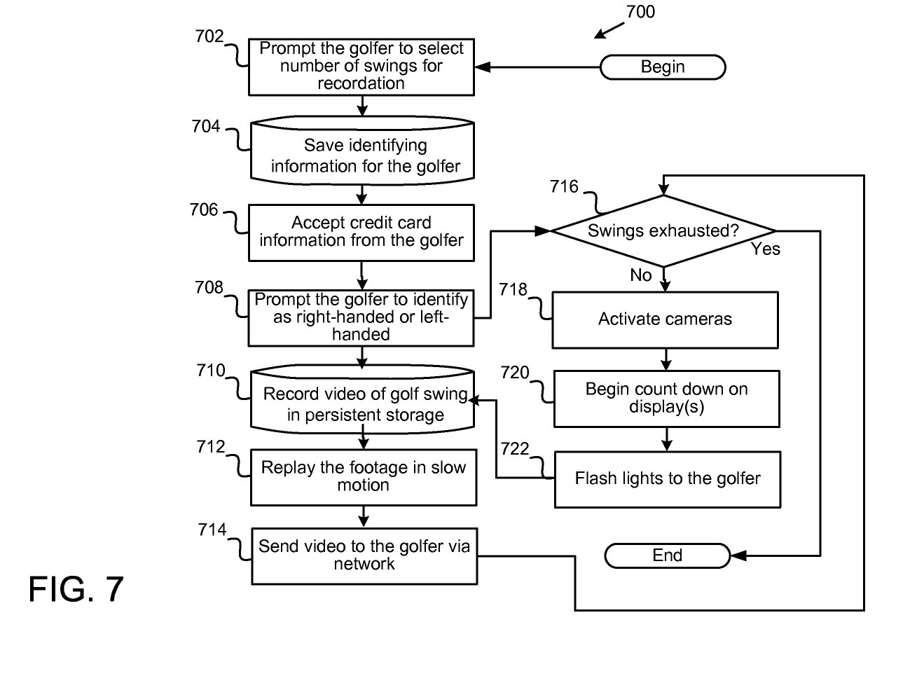

FIG. 7 is a flow chart of the steps of a method 700 or computer program 700 product or recording and facilitating review of digital video media of a golf swing in accordance with the present invention.

The steps of the method 700 may be effectuated by a DPD in accordance with instructions written in computer readable persistent memory.

The method 700 begins and the golfer 102 is prompted 602 to select a number of swings with the golfer 102 would like recorded. The golfer may be prompted to register in a virtual framework, and may be prompted or required to input personal identifying information, such as name, email address, phone number, and the like. This information is saved 704 in computer readable memory 508.

The golfer 102 is prompted to input payment information. This payment information may comprise credit card numbers, PayPal®, checking information, gift cards, or the like. The payment information is accepted 706, and the golfer is prompted 708 to identify himself or herself as right-handed golfer or a left-handed golfer.

If 716 the golfer 102 still has golf swings which have been paid for but not yet recorded, the cameras 104a-c are activated, a countdown of the seconds left until recording begins is shown 720 on one or more of the displays 108a-b; and, in some embodiment, lights 202a-b flash 722 to indicate the start of filming.

The swing of the golfer 102 is recorded 710 using the cameras 104a-c, and the video footage of the golf swing is written into persistent computer readable storage 708. In some embodiments of the present invention, the golfer 102 starts the recording by depressing a button disposed at, on or near the standing pad 114.

Using the interface, the golfer 102 may instruct that the footage be replayed. The footage is then replayed 712 in response to the golfer's 102 instruction.

When the video is played back on one of the displays 108a-c, or on a website accessible by the golfer 102. In various embodiments, the golfer 102 may choose to playback a video of his swing that is superimposed over a video of the swing of a professional golfer. In various embodiments, video recordings of the swings of one or more professional golfers are stored in computer readable memory.

In accordance with the present invention, a golfer 102 may playback a video recording of his own golf swing superimposed digitally on the display over a video recording of a professional golfer's swing using means known to those of skill in the art. The golfer 102 is provided with functionality enabling the golfer 102 to slow down or speed up the playback rate of both his swing and/or the professional golfer's swing. The golfer 102 may pause the playback, or zoom in or out during playback or while the playback is paused.

In various embodiments of the present invention, the playback takes place on one of the displays 108a-b, which displays 108a-b may also comprise projectors. The golfer 102 is provided with functionality that allow the golfer 102 to draw, using a touchscreen or mouse, onto the digitally displayed playback such that the golfer 102 may draw lines, or multicolored lines, tracking the trajectory of a golf swing.

In some embodiments, the golfer 102 may separately track the trajectory of his own swing as recorded and displayed on the display 108a-b, and may also separately track the trajectory of a professional golfer's swing using graphics interposed by the golfer 102 on the touchscreen. These golfer 102 imposed graphics may be interposed upon one another during playback along with the video.

In various embodiments of the present invention, a three dimensional (3D) video images of the golfer's 102 swing is assembled by the displays 108a-b or ancillary DPDs using three camera 104a-c perspectives. The video of the golfer's 102 swing is played back from one of the perspectives, but the golfer 102 is provided with functionality allowing the golfer 102 to view the swing from other perspectives by axially rotating the perspective view of the golfer 102 during playback. In some embodiments, the golfer 102 simply switching from one perspective recording of a camera 104 to the perspective recording of a second or third camera 104, but in other embodiments, the golfer 102 is shown a composite perspective recording, or a perspective view created by a DPD from the information drawn from the other perspective recordings using means known to those of skill in the art.

Users have the option to super impose another golfers swing video over their own video either at our kiosk station or on the website

Users have the option to super impose a mechanical swing over their swing video over their own swing video at the kiosk station or on the website

Users can use our website tools such as slow motion, drawing lines, drawing circles to analyze their swing.

The digital recording of the golf swing may be sent to the golfer 102 as described above in relation to FIGS. 1-6.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for improving a golf swing, the system comprising:
a planar standing pad resting on a ground surface for supporting a golfer swinging a golf club;
three or more digital cameras capable of recording more than 100 frames per second having wide angle lenses, each camera pointed at a center of the standing pad, each camera affixed to one of a plurality of camera stands;
the plurality of camera stands, each camera stand detachably affixed to one of the three or more digital cameras, each of the camera stands affixed to an interior wall of a room;
three or more cables, each cable interconnecting one of the cameras with a DPD (data processing device);
a DPD in logical communication with a first display and a second display, the DPD networked to an Internet;
an interface for receiving payment information entered by a golfer;
the display for displaying video media shot by the cameras, the first display affixed to an interior wall of a room; and
a persistent computer readable storage for storing video media shot by the cameras.

2. The system of claim 1, further comprising
a prompter module configured to prompt a golfer to input a number of swings the golfer wishes to pay to have reviewed;
an incorporation module configured to incorporate a golfer into a virtual framework, the incorporation module configured to store the golfer's name and email in a database record in the persistent computer readable storage;
a payment module configured to accept a credit card payment from the golfer, the payment a function of the number of swings selected by the golfer;
a hand selector module configured to prompt the golfer to identify himself/herself as one of a right-handed golfer and a left-handed golfer;
a recorder module configured to record the swing of the golfer from a plurality of perspectives, the recordings of the golf swing from each perspective stored in persistent computer readable memory;
a superimposer module configured to superimpose a prerecorded video of a professional golfer swinging a golf club over one of the video recordings of the golf swing; and
a transfer module configured to transfer a video recording of the golfer's swing as an attachment to the email address.

3. The system of claim 2, further comprising:
a lighter module configured to flash one or more light(s) to indicate to the golfer that video recording is about to ensue, the lights affixed to a table; and
one or more light(s) connected the lighter module.

4. A golf swing review device comprising:
a planar standing pad resting on a ground surface for supporting a golfer swinging a golf club;
three or more digital cameras capable of recording more than 100 frames per second having wide angle lenses affixed to the standing pad, each camera pointed at a center of the standing pad, the cameras each affixed to a camera stand, wherein each camera communicates wirelessly with a DPD (data processing device);
three or more camera stands, each camera stand detachably affixed to one of the three or more cameras, the camera stands resting on the ground surface;
an interface for receiving payment information entered by a golfer;
a display for displaying video media shot by the cameras; and
a DPD in logical communication with a first display and a second display, the DPD networked to an Internet.

5. The golf swing review device of claim 4, wherein the display faces the standing pad such the golfer can see the display while standing on the pad.

6. The golf swing review device of claim 4, further comprising one or more light(s) configured to flash so as to indicate that recording of a golf swing is about to begin.

7. The golf swing review device of claim 4, further comprising two or more disassemblable, interconnectable walls surrounding the standing pad.

8. A computer program product comprising a non-transitory computer readable medium having computer usable program code executable to perform operations for providing visual review of recorded golf swing, the operations of the computer program product comprising:
prompting a golfer to input a number of swings the golfer wishes to pay to have reviewed;
incorporating a golfer into a virtual framework, the incorporation module configured to store the golfer's name and email in a database record in the persistent computer readable storage;
accepting a credit card payment from the golfer, the payment a function of the number of swings selected by the golfer;
prompting the golfer to identify himself/herself as one of a right-handed golfer and a left-handed golfer; and
recording the swing of the golfer from a plurality of perspectives, the recordings of the golf swing stored in persistent computer readable memory; and
transferring a video recording of the golfer's swing as an attachment to the email address.

9. The computer program product of claim 8, further comprising:
counting down the seconds until recording starts, and displaying a countdown on a display.

10. The computer program product of claim 8, further comprising: accepting a plurality of commands uttered orally by the golfer using voice recognition software.

11. The computer program product of claim 8, further comprising:
prompting the golfer to replay footage of the golfer's recorded swing on a display, the golfer prompted to display footage from one of a first perspective, a second perspective, a third perspective, or all perspectives; and
playing the recorded media on the display in slow motion from the selected perspective(s) in response to the golfer starting replay.

12. The computer program product of claim 8, further comprising:
prompting the golfer to start a slow motion replay of the golfer's recorded swing on a display; and
playing the recorded media on the display in slow motion in response to the golfer starting replay.

13. The computer program product of claim 8, further comprising:
prompting the golfer to select from one or more perspective views used to record the golfer's swing; and
playing the recorded media footage taken from the selected perspective on the display in (Any motion) slow motion in response to the golfer starting replay.
